(19) United States
(12) Patent Application Publication
(10) Pub. No.: US 2015/0286083 A1
(43) Pub. Date: Oct. 8, 2015

(54) DUAL-LAYERED BIAXIAL COMPENSATION STRUCTURE FOR LIQUID CRYSTAL PANELS AND THE LIQUID CRYSTAL DISPLAYS

(71) Applicant: Shenzhen China Star Optoelectronics Technology Co. Ltd., Shenzhen, Guangdong (CN)

(72) Inventors: Chih-tsung Kang, Shenzhen City (CN); Bo Hai, Shenzhen City (CN)

(21) Appl. No.: 14/358,593

(22) PCT Filed: Apr. 11, 2014
(86) PCT No.: PCT/CN2014/075127

§ 371 Date: May 15, 2014

(30) Foreign Application Priority Data
Apr. 4, 2014 (CN) 201410136954.5

(51) Int. Cl. G02F 1/13363; G02F 1/1335; G02F 1/1337

(52) U.S. Cl. CPC G02F 1/13363; G02F 1/1337; G02F 1/133528; G02F 2001/133742; G02F 2413/12

(57) ABSTRACT

A dual-layered biaxial compensation structure including a first polarizing film, a first biaxial compensation film, a liquid crystal panel, a second biaxial compensation film, and a second polarizing film arranged in sequence. The liquid crystal panel includes a liquid crystal layer. An anisotropy reflective index, a thickness, and a pretilt angle of the liquid crystal layer are respectively Δn, d and θ. An in-plane retardation value and a thickness retardation value of the first biaxial compensation film are respectively Ro1 and Rth1, and the in-plane retardation value and the thickness retardation value of the second biaxial compensation film are respectively Ro2 and Rth2, wherein: 287.3 nm≦Δn×d≦305.7 nm; 85°≦θ<90°; 8 nm≦Ro1≦98 nm; 19 nm≦Rth1≦224 nm; 8.4 nm≦Ro2≦98 nm; Y1 nm≦Rth2≦Y2 nm; Y1=0.003115×(Rth1)²−1.6791×Rth1+231.67; and Y2=−0.002225×(Rth1)²−0.37474×Rth1+241.7.

### BACKGROUND OF THE INVENTION

1. Field of the Invention

The present disclosure relates to liquid crystal display technology, and more particularly to a dual-layered biaxial compensation structure for liquid crystal panels and the liquid crystal display (LCD) with the same.

2. Discussion of the Related Art

LCDs are flat and thin display devices including a plurality of colorful or black pixels arranged in front of a light source or a reflective surface. In addition to the low power consumption, the LCDs also characterized by attributes including high display performance, small dimension, and light weight, and thus have become the main stream of the display devices. Currently, thin film transistor (TFT) LCD is the most popular one.

With the increasing dimension of TFT-LCD, the viewing angle also increases, which results in the decreasing contrast and resolution. This is mainly due to the changed birefringence index of the liquid crystal molecules. It is known that the brightness may greatly decreased when the viewing angle equals to a specific value. The viewing angle for traditional LCD usually equals to 90 degrees, that is, 45 degrees for both the right side and the left side. The linear liquid crystal for manufacturing the liquid crystal panel is the material with birefringence index Δn. When passing through the liquid crystal molecules, the light beams may be divided into ordinary rays and extraordinary rays. If the light beams oblique incidents on the liquid crystal molecules, two reflective light beams are generated. The birefringence index Δn=ne−no, where “ne” represents the reflective index of the liquid crystal molecules relating to ordinary light beams and “no” represents the reflective index of the liquid crystal molecules relating to non-ordinary light beams. Thus, when the light beams pass through the liquid crystal molecules between the two glasses, phase retardation occurs. The optical characteristics of the liquid crystal cell is usually evaluated by the phase retardation, i.e., Δn×d, which is usually called as the optical path difference, where Δn represents the birefringence index and d represents the thickness of the liquid crystal cell. The above mentioned problem is caused by the different phase retardation in different viewing angles. The phase retardation of good optical compensation film may offset that of the linear liquid crystal molecules so as to increase the visible angle of the liquid crystal panel. The compensation principle of the optical compensation film relates to alter the phase difference resulting from different viewing angles. In this way, the birefringence liquid crystal molecules can be compensated symmetrically. By adopting the optical compensation film, the dark-state light leakage may be greatly reduced, and the contrast can also be greatly enhanced within a certain viewing angle. The optical compensation film includes retardation films, compensation films, wide view films, and so on. The optical compensation film can reduce the light leakage amount in the dark-state. In addition, the contrast and color saturation can be greatly enhanced, and some inversed gray scale issue can be overcome. The parameters for evaluating the optical compensation film includes an in-plane delay Ro, a thickness direction delay Rth, a refractive rate N, and a film thickness D. The following equations are satisfied:

Ro=(Nx−Ny)×D;

Rth=[(Nx+Ny)/2−Nz]×D;

Wherein, Nx is a refractive index along the slow axis in the plane of the film (having a maximum refractive index axis, i.e., light having a slower velocity of propagation of the vibration direction), Ny is a refractive index along a fast axis in the plane of the film (having a minimum refractive index axis, that is, light having a vibration direction of the fast propagation rate, perpendicular to Nx), and Nz is a refractive index in the plane of the film (perpendicular to Nx and Ny).

Different optical compensation films are adopted for different display modes, i.e., liquid crystal cells. Also, the values of Ro and Rth have to be configured accordingly. Currently, the optical compensation films adopted by the large-scale LCDs focus on the vertical alignment (VA) display mode. In the past, the optical compensation films, including N-TAC developed by Konica, Zeonor developed by OPTES, F-TAC developed by Fujitsu, and X-plate developed by Nitto Denko are adopted in sequence.

It is known that the optical path difference may result in a large amount of liquid crystal molecules, which increases the cost. Thus, one feasible solution is to decrease the optical path difference. However, the smaller optical path difference may cause serious dark-state light leakage for large-scale liquid crystal panels, and thus result in low contrast and resolution at large viewing angle. FIG. 1 is a diagram depicting the dark-state brightness distribution at all viewing angles of one conventional dual-layered biaxial compensation structure after being compensated. FIG. 2 is a diagram depicting the dark-state contrast distribution at all viewing angles of the liquid crystal panel of FIG. 1. The optical path difference Δn×d=296.5 nm. It can be seen from FIGS. 1 and 2 that the light leakage is serious for the locations at phi=30−60°, phi=120−150°, phi=210−240° and phi=300−330°. In addition, the contrast and the resolution at the above locations are quite low.

### SUMMARY

To overcome the above problem, the dual-layered biaxial compensation structure for the liquid crystal panels is capable of greatly reducing the dark-state light leakage by configuring the retardation values for the liquid crystal panel with low optical path difference. In addition, the contrast and the resolution in wide viewing angle can be enhanced.

In one aspect, a dual-layered biaxial compensation structure includes: a liquid crystal panel and a first polarizing film and a second polarizing film arranged on two opposite surfaces of the liquid crystal panel, a first biaxial compensation film arranged between the liquid crystal panel and the first polarizing film, and a second biaxial compensation filmsecond biaxial compensation film arranged between the liquid crystal panel and the second polarizing film, the liquid crystal panel comprises a liquid crystal layer having a plurality of liquid crystal molecules, an anisotropy reflective index of the liquid crystal layer is Δn, the thickness of the liquid crystal layer is d, a pretilt angle of the liquid crystal molecules is θ, an in-plane retardation value and a thickness retardation value of the first biaxial compensation film are respectively Ro1 and Rth1, and the in-plane retardation value and the thickness retardation value of the second biaxial compensation filmsecond biaxial compensation film are respectively Ro2 and Rth2, wherein:

287.3 nm≦Δn×d≦305.7 nm;

85°≦θ<90°;

8 nm≦Ro1≦98 nm;

19 nm≦Rth1≦224 nm;

8.4 nm≦Ro2≦98 nm;

Y1 nm≦Rth2≦Y2 nm;

Y1=0.003115×(Rth1)²−1.6791×Rth1+231.67;

and

Y2=−0.002225×(Rth1)²−0.37474×Rth1+241.7.

Wherein 43 nm≦Ro1, Ro2≦62.3 nm, 98.2 nm≦Rth1, and Rth2≦142.4 nm.

Wherein Ro1=Ro2 and Rth1=Rth2.

Wherein the first polarizing film and the second polarizing film are made by Polyvinyl alcohol (PVA).

Wherein a first protection film for protecting the first polarizing film is arranged on a down surface of the first polarizing film, and the down surface is opposite to the first biaxial compensation film, and a second protection film for protecting the second polarizing film is arranged on an up surface of the second polarizing film, and the up surface is opposite to the second biaxial compensation filmsecond biaxial compensation film.

Wherein the second protection film and the second protection film are made by Triacetyl Cellulose (TAC)

Wherein an included angle between a light absorbing axis of the first polarizing film and a slow axis of the first biaxial compensation film is 90 degrees, and the included angle between the light absorbing axis of the second polarizing film and the slow axis of the second biaxial compensation filmsecond biaxial compensation film is 90 degrees.

Wherein the liquid crystal panel is a vertical alignment mode.

In another aspect, a liquid crystal device includes a liquid crystal display panel and a backlight module arranged opposite to the liquid crystal display panel. The backlight module provides a light source to the liquid crystal display panel such that the liquid crystal display panel is capable of displaying images. The liquid crystal display panel adopts the above dual-layered biaxial compensation structure.

In view of the above, the dual-layered biaxial compensation structure for the liquid crystal panel is capable of greatly reducing the dark-state light leakage by configuring the retardation values for the liquid crystal panel with low optical path difference. In addition, the contrast and the resolution in wide viewing angle can be enhanced.

### BRIEF DESCRIPTION OF THE DRAWINGS

FIG. 1 is a diagram depicting the dark-state brightness distribution at all viewing angles of one conventional dual-layered biaxial compensation structure after being compensated.

FIG. 2 is a diagram depicting the dark-state contrast distribution at all viewing angles of the liquid crystal panel of FIG. 1.

FIG. 3 is a schematic view showing the liquid crystal device in accordance with one embodiment.

FIG. 4 is a schematic view showing the dual-layered biaxial compensation structure in accordance with one embodiment.

FIG. 5 is a trend diagram showing the relationship between the dark-state light leakage and the retardation values when the optical path difference is 287.3 nm in accordance with one embodiment.

FIG. 6 is a trend diagram showing the relationship between the dark-state light leakage and the retardation values where the optical path difference is 305.7 nm in accordance with one embodiment.

FIG. 7 is a diagram depicting the dark-state brightness distribution at all viewing angles of the dual-layered biaxial compensation structure after being compensated in accordance with one embodiment.

FIG. 8 is a diagram depicting the dark-state contrast distribution at all viewing angles of the liquid crystal panel of FIG. 7.

FIG. 9 is a diagram depicting the dark-state brightness distribution at all viewing angles of the dual-layered biaxial compensation structure after being compensated in accordance with another embodiment.

FIG. 10 is a diagram depicting the dark-state contrast distribution at all viewing angles of the liquid crystal panel of FIG. 9.

FIG. 11 is a diagram depicting the dark-state brightness distribution at all viewing angles of the dual-layered biaxial compensation structure after being compensated in accordance with another embodiment.

FIG. 12 is a diagram depicting the dark-state contrast distribution at all viewing angles of the liquid crystal panel of FIG. 11.

FIG. 13 is a trend diagram showing the relationship between the dark-state light leakage and the retardation values where the optical path difference Δn×d is 287.3 nm and the pretilt angles are different in accordance with one embodiment.

FIG. 14 is a trend diagram showing the relationship between the dark-state light leakage and retardation values where the optical path difference Δn×d is 305.7 nm, and the pretilt angles are different in accordance with one embodiment.

FIG. 15 is a diagram depicting the dark-state brightness distribution at all viewing angles of the dual-layered biaxial compensation structure after being compensated in accordance with another embodiment.

FIG. 16 is a diagram depicting the dark-state contrast distribution at all viewing angles of the liquid crystal panel of FIG. 9.

### DETAILED DESCRIPTION OF THE EMBODIMENTS

Embodiments of the invention will now be described more fully hereinafter with reference to the accompanying drawings, in which embodiments of the invention are shown.

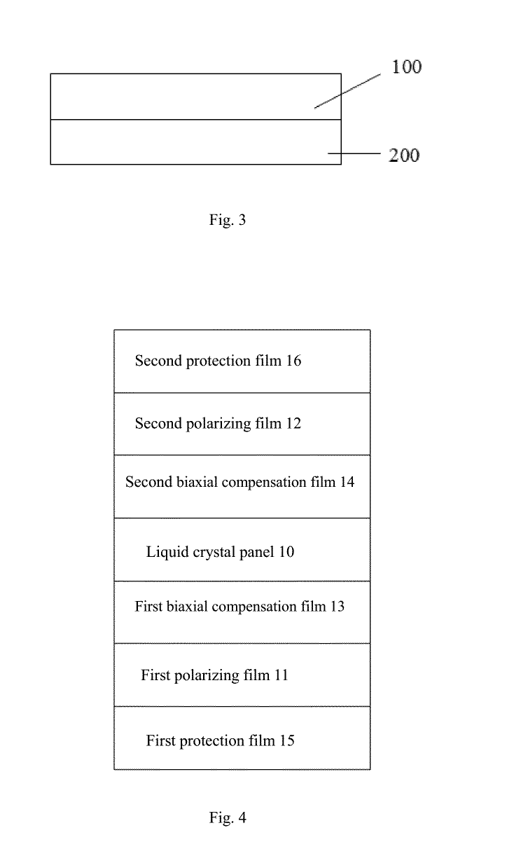

Referring to FIG. 3, the LCD includes a liquid crystal display panel 100 and a backlight module 200 arranged opposite to the liquid crystal display panel 100. The backlight module 200 provides a light source to the liquid crystal display panel 100 such that the liquid crystal display panel 100 can display images. The liquid crystal display panel 100 is the liquid crystal panel adopting a dual-layered biaxial compensation structure.

FIG. 4 shows the dual-layered biaxial compensation structure including a first polarizing film 11, a first biaxial compensation film 13, a liquid crystal panel 10, a second biaxial compensation film 14 and a second polarizing film 12 from bottom to up. The liquid crystal panel 10 is a VA liquid crystal cell (VA cell). The first polarizing film 11 and the second polarizing film 12 are made by Polyvinyl alcohol (PVA). An included angle between a light absorbing axis of the first polarizing film 11 and a slow axis of the first biaxial compensation film 13 is configured to be 90 degrees. The included angle between the light absorbing axis of the second polarizing film 12 and the slow axis of the second biaxial compensation film 14 is configured to be 90 degrees. In the embodiment, the first biaxial compensation film 13 is arranged above the first polarizing film 11, and a first protection film 15 is arranged on a down surface of the first polarizing film 11, and the down surface is opposite to the first biaxial compensation film. In addition, the second biaxial compensation film 14 is arranged below the second polarizing film 12, and a second protection film 16 is arranged on an up surface of the second polarizing film 12, and the up surface is opposite to the second biaxial compensation film. The first protection film 15 and the second protection film 16 are made by Triacetyl Cellulose (TAC). The first protection film 15 and the second protection film 16 are mainly for protecting the first PVA polarizing film 11 and the second PVA polarizing film 12, for enhancing the mechanical functions of the first PVA polarizing film 11 and the second PVA polarizing film 12, and for preventing the first PVA polarizing film 11 and the second PVA polarizing film 12 from retraction. The liquid crystal panel 10 includes a liquid crystal layer having a plurality of liquid crystal molecules. The anisotropy reflective index of the liquid crystal layer is Δn, the thickness of the liquid crystal layer is d, and the pretilt angle of the liquid crystal molecules is θ. In the above example, the in-plane retardation value of the first biaxial compensation film 13 is Ro1, and the thickness retardation is Rth1, the in-plane retardation value of the second biaxial compensation film 14 is Ro2, and the thickness retardation value of the first protection film 14 is Rth2.

The above structure mainly focuses on the liquid crystal panel with low optical path difference. By configuring appropriate retardation values for the first biaxial compensation film 13 and second biaxial compensation film 14, the dark-state light leakage can be greatly reduced. Thus, the contrast and the resolution in wide viewing angle can be increased.

The following configurations are adopted in related simulations.

The liquid crystal layer is configured as below.

1. The pretile angle θ: 85°≦θ<90°;

2. The pretile angles for four dimensions are respectively 45, 135, 225, 315 degrees; and

3. The optical path difference Δn×d: 287.3 nm≦Δn×d≦305.7 nm.

The backlight source is configured as below:

1. Light source: Blue-YAG LED optical spectrum;

2. The central brightness of the light source is 100 nit; and

3. The light source distribution is Lambert's distribution.

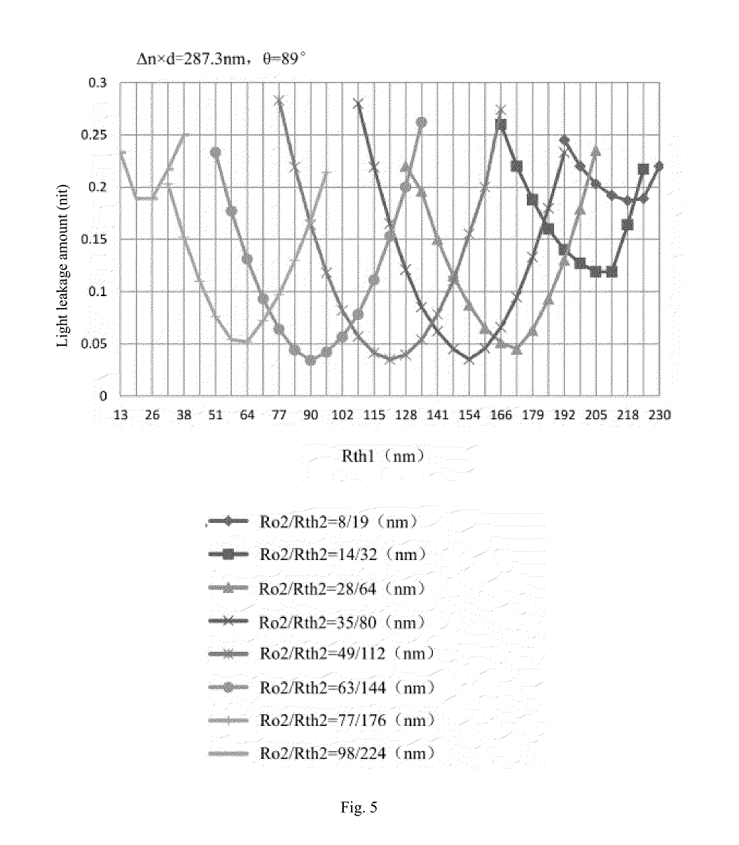

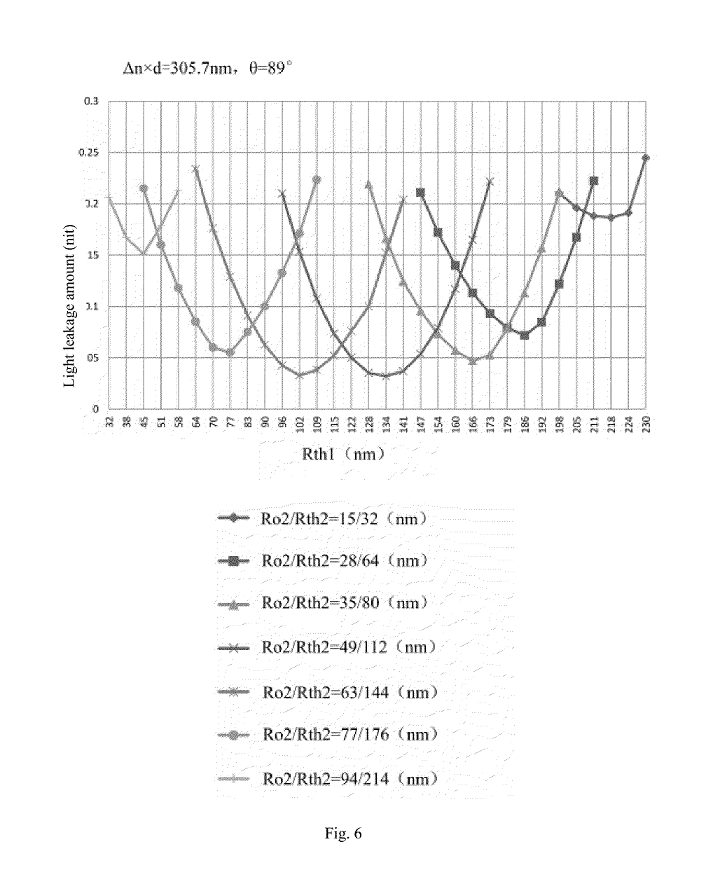

FIG. 5 is a trend diagram showing the relationship between the dark-state light leakage and the retardation values for the conditions including the optical path difference is 287.3 nm and the pretile angle is 89 degrees. FIG. 6 is a trend diagram showing the relationship between the dark-state light leakage and the retardation values where the optical path difference is 305.7 nm and the pretile angle is 89 degrees. The simulations are conducted by combinations of different pretile angles and retardation values, and the conditions include: 287.3 nm≦Δn×d≦305.7 nm; 85°≦θ<90°; and the dark-state light leakage is smaller than 0.2 nit. The corresponding ranges of the retardation values for the first biaxial compensation film 13 and second biaxial compensation film 14 are: 8 nm≦Ro1≦98 nm; 19 nm≦Rth1≦224 nm; 8.4 nm≦Ro2≦98 nm; Y1 nm≦Rth2≦Y2 nm; wherein

Y1=0.003115×(Rth1)²−1.6791×Rth1+231.67;

and

Y2=−0.002225×(Rth1)²−0.37474×Rth1+241.7.

The retardation values of the compensation film, including Ro, Rth, the reflective index N and the thickness D, satisfy the equations below:

Ro=(Nx−Ny)×D;

Rth=[(Nx+Ny)/2−Nz]×D;

Thus, the retardation values may be changed by three methods.

1. The thickness D is changed while the reflective index N of the biaxial compensation film remains the same.

2. The reflective index N is changed while the thickness D of the biaxial compensation film remains the same.

3. The thickness D and the reflective index N are changed at the same time, but the ranges of the retardation values of the biaxial compensation film are guaranteed.

Some of the retardation values are selected to test the compensation result so as to further describe the technical effects of the present disclosure.

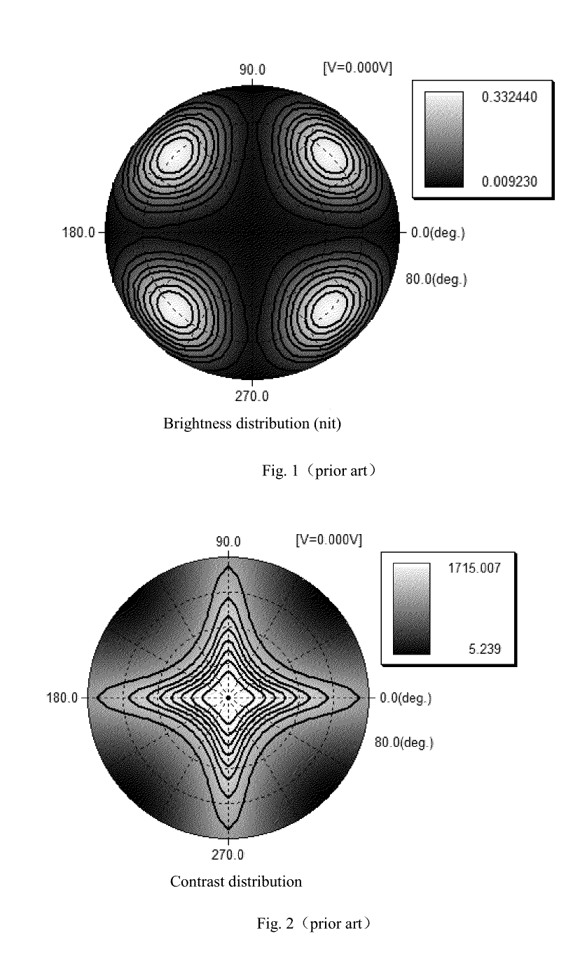

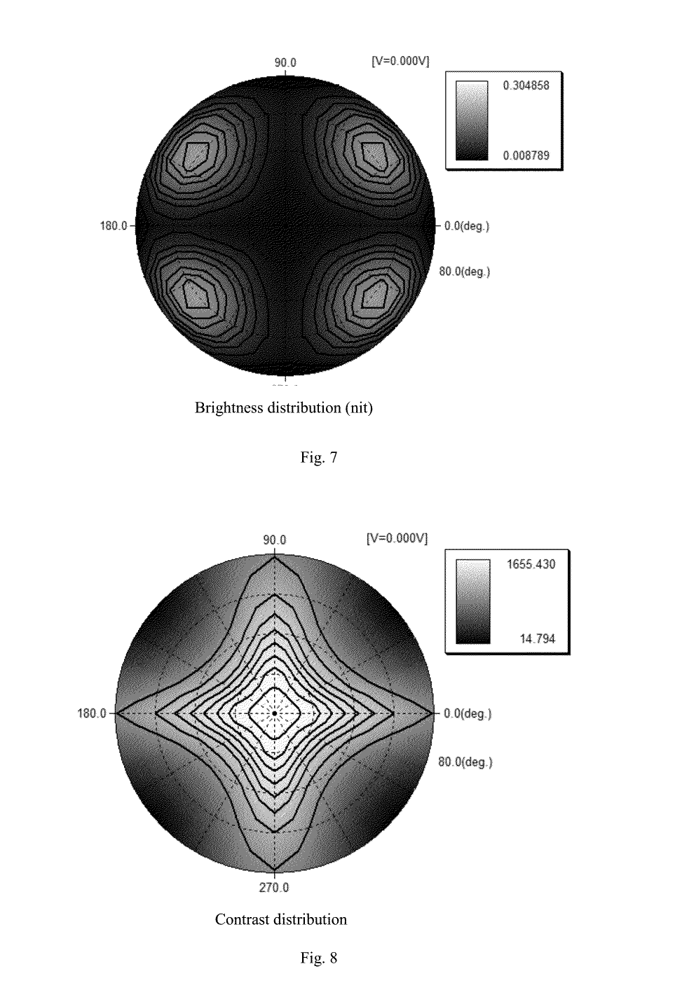

FIG. 7 is a diagram depicting the dark-state brightness distribution at all viewing angles of the dual-layered biaxial compensation structure after being compensated in accordance with one embodiment. FIG. 8 is a diagram depicting the dark-state contrast distribution at all viewing angles of the liquid crystal panel of FIG. 7. The conditions set for FIGS. 7 and 8 include: the optical path difference Δn×d=296.5 nm, the pretilt angle θ=89°, Ro1=56 nm, Rth1=128 nm, Ro2=33.6 nm, Rth2=76.8 nm. Comparing FIG. 7 with FIG. 1, it can be seen that the dark-state light leakage of the compensation structure of FIG. 7 is much lower than that of FIG. 1. Comparing FIG. 8 with FIG. 2, it can be seen that the contrast distribution for all viewing angles of FIG. 8 is better than that of FIG. 2.

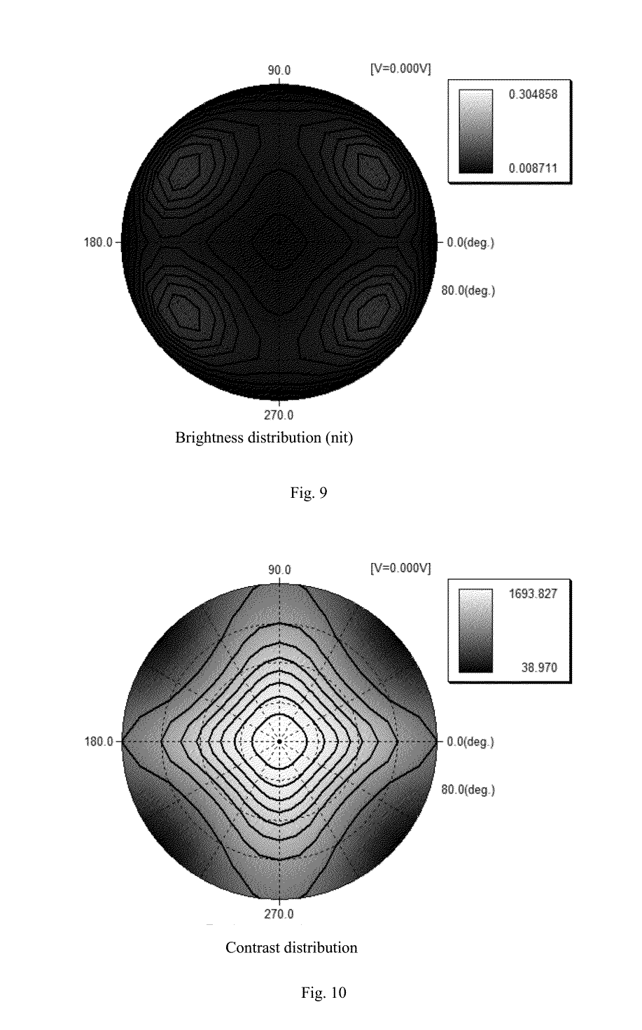

FIG. 9 is a diagram depicting the dark-state brightness distribution at all viewing angles of the dual-layered biaxial compensation structure after being compensated in accordance with another embodiment. FIG. 10 is a diagram depicting the dark-state contrast distribution at all viewing angles of the liquid crystal panel of FIG. 9. The conditions set for FIGS. 9 and 10 include: optical path difference Δn×d=296.5 nm, pretilt angle θ=89°, Ro1=56 nm, Rth1=128 nm, Ro2=42 nm, Rth2=128 nm. Comparing FIG. 9 with FIG. 1, it can be seen that the dark-state light leakage of the compensation structure of FIG. 9 is much lower than that of FIG. 1. Comparing FIG. 10 with FIG. 2, it can be seen that the contrast distribution for all viewing angles of FIG. 10 is better than that of FIG. 2.

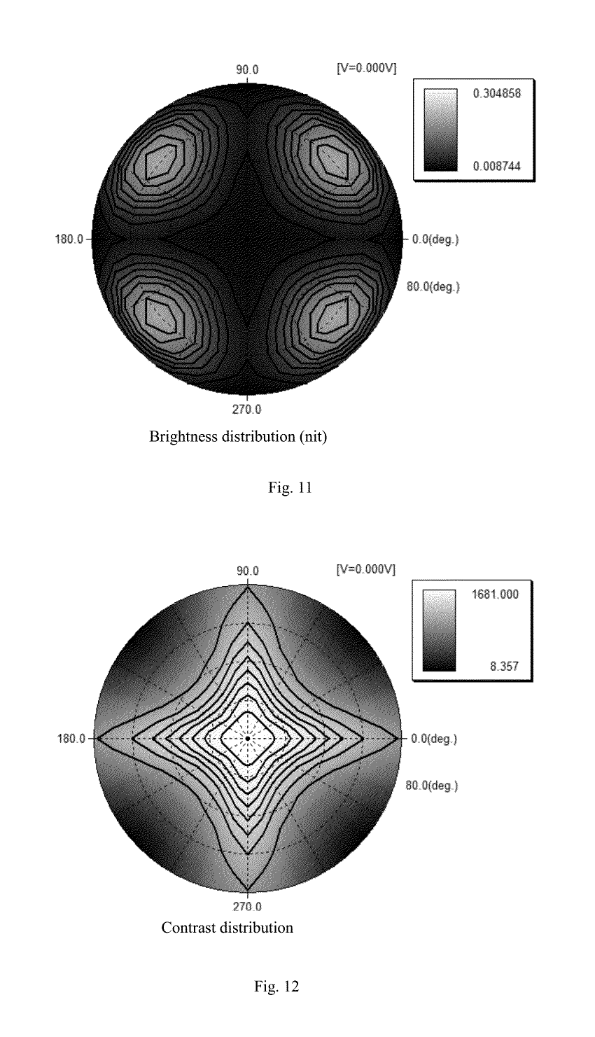

FIG. 11 is a diagram depicting the dark-state brightness distribution at all viewing angles of the dual-layered biaxial compensation structure after being compensated in accordance with another embodiment. FIG. 12 is a diagram depicting the dark-state contrast distribution at all viewing angles of the liquid crystal panel of FIG. 11. The conditions set for FIGS. 11 and 12 include: the optical path difference Δn×d=296.5 nm, the pretilt angle θ=89°, Ro1=56 nm, Rth1=128 nm, Ro2=65.8 nm, Rth2=150.4 nm. Comparing FIG. 11 with FIG. 1, it can be seen that the dark-state light leakage of the compensation structure of FIG. 11 is much lower than that of FIG. 1. Comparing FIG. 12 with FIG. 2, it can be seen that the contrast distribution for all viewing angles of FIG. 12 is better than that of FIG. 2.

The values of the above parameters, including optical path difference Δn×d, pretilt angle θ and Ro1, Rth1, Ro2 and Rth2 are only taken as examples for some embodiments. The parameters are selected within the following ranges: 287.3 nm≦Δn×d≦305.7 nm; 85°≦θ<90°; 8 nm≦Ro1≦98 nm; 19 nm≦Rth1≦224 nm; 8.4 nm≦Ro2 ≦98 nm; Y1 nm≦Rth2≦Y2 nm; Y1=0.003115×(Rth1)²−1.6791×Rth1+231.67; and Y2=−0.002225×(Rth1)²−0.37474×Rth1+241.7.

In the manufacturing process, the retardation values of the second polarizing film 12 and the second biaxial compensation film 14 are the same, and thus the process is efficient and the cost is low.

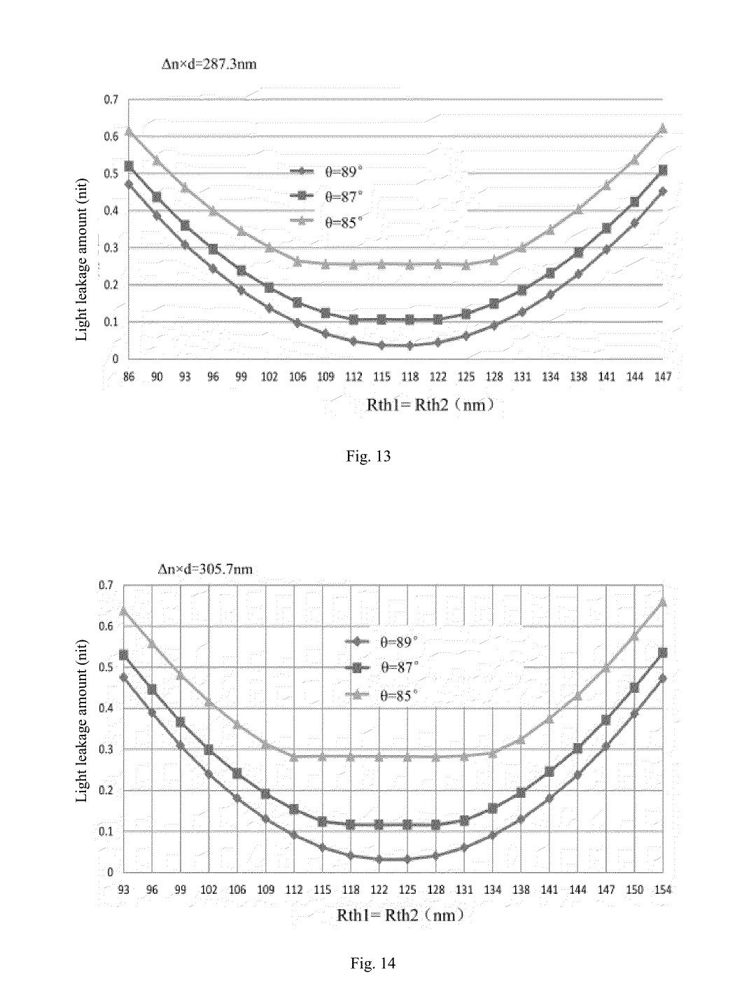

FIG. 13 is a trend diagram showing the relationship between the dark-state light leakage and the retardation values where the optical path difference Δn×d is 287.3 nm, and the pretilt angle θ are respectively 85°, 87°, and 89°. FIG. 14 is a trend diagram showing the relationship between the dark-state light leakage and retardation values where the optical path difference Δn×d is 305.7 nm, and the pretilt angle θ are respectively 85°, 87°, and 89°. In view of FIGS. 13 and 14, combinations of different pretilt angles and different retardation values are simulated so as to obtain similar trend of the relationship between the dark-state light leakage and the retardation values. The reasonable range of the retardation values include: 43 nm≦Ro1=Ro2≦62.3 nm; 98.2 nm≦Rth1=Rth2≦142.4 nm when the conditions are: (1) 87.3 nm≦Δn×d≦305.7; (2) 85°≦θ<90°; (3) the second polarizing film 12 and the second biaxial compensation film 14 have the same retardation values; and (4) the dark-state light leakage is less than 0.2 nit.

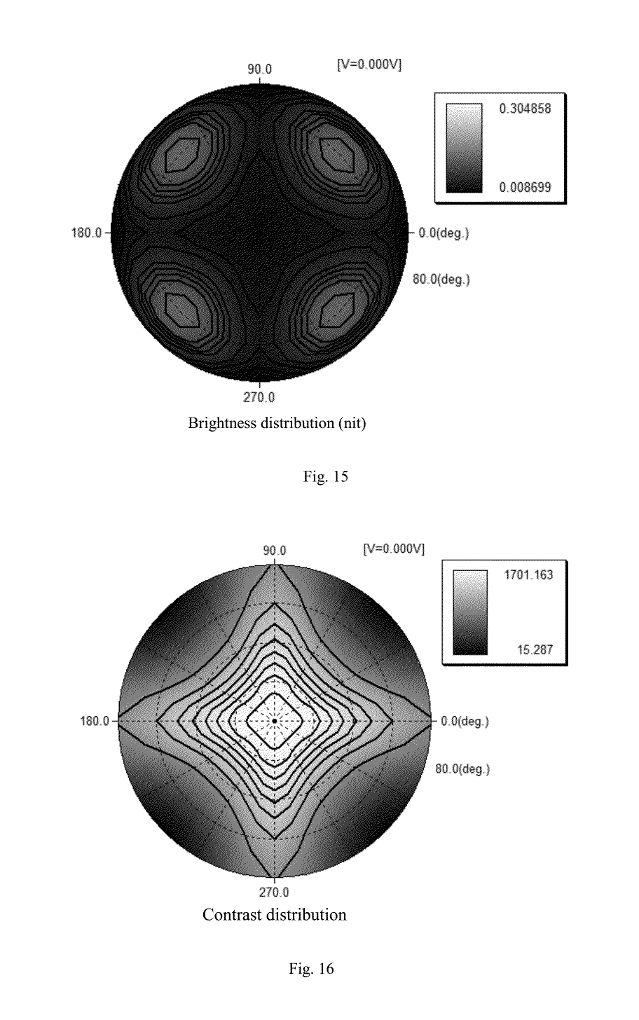

The following examples of which the second polarizing film 12 and the second biaxial compensation film 14 have the same retardation values will be described hereinafter. FIG. 15 is a diagram depicting the dark-state brightness distribution at all viewing angles of the dual-layered biaxial compensation structure after being compensated in accordance with another embodiment. FIG. 16 is a diagram depicting the dark-state contrast distribution at all viewing angles of the liquid crystal panel of FIG. 9. The conditions set for FIGS. 15 and 16 include: the optical path difference Δn×d=296.5 nm, the pretilt angle θ=89°, Ro1=Ro2=58.8 nm, and Rth1=Rth2=134.4 nm. Comparing FIG. 15 with FIG. 1, it can be seen that the dark-state light leakage of the compensation structure of FIG. 15 is much lower than that of FIG. 1. Comparing FIG. 16 with FIG. 2, it can be seen that the contrast for all viewing angles of FIG. 16 is better than that of FIG. 2.

In view of the above, the dual-layered biaxial compensation structure for the liquid crystal panel is capable of greatly reducing the dark-state light leakage by configuring the retardation values for the liquid crystal panel with low optical path difference. In addition, the contrast and the resolution in wide viewing angle can be enhanced.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A dual-layered biaxial compensation structure, comprising:
a liquid crystal panel and a first polarizing film and a second polarizing film arranged on two opposite surfaces of the liquid crystal panel, a first biaxial compensation film arranged between the liquid crystal panel and the first polarizing film, and a second biaxial compensation film arranged between the liquid crystal panel and the second polarizing film, the liquid crystal panel comprises a liquid crystal layer having a plurality of liquid crystal molecules, an anisotropy reflective index of the liquid crystal layer is Δn, the thickness of the liquid crystal layer is d, a pretilt angle of the liquid crystal molecules is θ, an in-plane retardation value and a thickness retardation value of the first biaxial compensation film are respectively Ro1 and Rth1, and the in-plane retardation value and the thickness retardation value of the second biaxial compensation film are respectively Ro2 and Rth2, wherein:
287.3 nm≦Δn×d≦305.7 nm;
85°≦θ<90°;
8 nm≦Ro1≦98 nm;
19 nm≦Rth1≦224 nm;
8.4 nm≦Ro2≦98 nm;
Y1 nm≦Rth2≦Y2 nm;
Y1=0.003115×(Rth1)²−1.6791×Rth1+231.67;
and
Y2=−0.002225×(Rth1)²−0.37474×Rth1+241.7.

2. The dual-layered biaxial compensation structure as claimed in claim 1, wherein 43 nm≦Ro1, Ro2≦62.3 nm, 98.2 nm≦Rth1, and Rth2≦142.4 nm.

3. The dual-layered biaxial compensation structure as claimed in claim 2, wherein Ro1=Ro2 and Rth1=Rth2.

4. The dual-layered biaxial compensation structure as claimed in claim 1, wherein the first polarizing film and the second polarizing film are made by Polyvinyl alcohol (PVA).

5. The dual-layered biaxial compensation structure as claimed in claim 3, wherein a first protection film for protecting the first polarizing film is arranged on a down surface of the first polarizing film, and the down surface is opposite to the first biaxial compensation film, and a second protection film for protecting the second polarizing film is arranged on an up surface of the second polarizing film, and the up surface is opposite to the second biaxial compensation film.

6. The dual-layered biaxial compensation structure as claimed in claim 4, wherein a first protection film for protecting the first polarizing film is arranged on a down surface of the first polarizing film, and the down surface is opposite to the first biaxial compensation film, and a second protection film for protecting the second polarizing film is arranged on an up surface of the second polarizing film, and the up surface is opposite to the second biaxial compensation film.

7. The dual-layered biaxial compensation structure as claimed in claim 6, wherein the first protection film and the second protection film are made by Triacetyl Cellulose (TAC).

8. The dual-layered biaxial compensation structure as claimed in claim 5, wherein an included angle between a light absorbing axis of the first polarizing film and a slow axis of the first biaxial compensation film is 90 degrees, and the included angle between the light absorbing axis of the second polarizing film and the slow axis of the second biaxial compensation film is 90 degrees.

9. The dual-layered biaxial compensation structure as claimed in claim 6, wherein the liquid crystal panel is a vertical alignment mode.

10. The dual-layered biaxial compensation structure as claimed in claim 8, wherein the liquid crystal panel is a vertical alignment mode.

11. A liquid crystal device, comprising:
a liquid crystal display panel and a backlight module arranged opposite to the liquid crystal display panel, the backlight module provides a light source to the liquid crystal display panel such that the liquid crystal display panel is capable of displaying images, the liquid crystal display panel adopts a dual-layered biaxial compensation structure comprises:
a liquid crystal panel and a first polarizing film and a second polarizing film arranged on two opposite surfaces of the liquid crystal panel, a first biaxial compensation film arranged between the liquid crystal panel and the first polarizing film, and a second biaxial compensation film arranged between the liquid crystal panel and the second polarizing film, the liquid crystal panel comprises a liquid crystal layer having a plurality of liquid crystal molecules, an anisotropy reflective index of the liquid crystal layer is Δn, the thickness of the liquid crystal layer is d, a pretilt angle of the liquid crystal molecules is θ, an in-plane retardation value and a thickness retardation value of the first biaxial compensation film are respectively Ro1 and Rth1, and the in-plane retardation value and the thickness retardation value of the second biaxial compensation film are respectively Ro2 and Rth2, wherein:
287.3 nm≦Δn×d≦305.7 nm;
85°≦θ<90°;
8 nm≦Ro1≦98 nm;
19nm≦Rth1≦224 nm;
8.4 nm≦Ro2≦98 nm;
Y1 nm≦Rth2≦Y2 nm;
Y1=0.003115×(Rth1)²−1.6791×Rth1+231.67;
and
Y2=−0.002225×(Rth1)²−0.37474×Rth1+241.7.

12. The liquid crystal device as claimed in claim 11, wherein 43 nm≦Ro1, Ro2≦62.3 nm, 98.2 nm≦Rth1, and Rth2≦142.4 nm.

13. The liquid crystal device as claimed in claim 12, wherein Ro1=Ro2 and Rth1=Rth2.

14. The liquid crystal device as claimed in claim 11, wherein the first polarizing film and the second polarizing film are made by Polyvinyl alcohol (PVA).

15. The liquid crystal device as claimed in claim 13, wherein a first protection film for protecting the first polarizing film is arranged on a down surface of the first polarizing film, and the down surface is opposite to the first biaxial compensation film, and a second protection film for protecting the second polarizing film is arranged on an up surface of the second polarizing film, and the up surface is opposite to the second biaxial compensation film.

16. The liquid crystal device as claimed in claim 14, wherein a first protection film for protecting the first polarizing film is arranged on a down surface of the first polarizing film, and the down surface is opposite to the first biaxial compensation film, and a second protection film for protecting the second polarizing film is arranged on an up surface of the second polarizing film, and the up surface is opposite to the second biaxial compensation film.

17. The liquid crystal device as claimed in claim 16, wherein the first protection film and the second protection film are made by Triacetyl Cellulose (TAC).

18. The liquid crystal device as claimed in claim 15, wherein an included angle between a light absorbing axis of the first polarizing film and a slow axis of the first biaxial compensation film is 90 degrees, and the included angle between the light absorbing axis of the second polarizing film and the slow axis of the second biaxial compensation film is 90 degrees.

19. The liquid crystal device as claimed in claim 16, wherein the liquid crystal panel is a vertical alignment mode.

20. The liquid crystal device as claimed in claim 18, wherein the liquid crystal panel is a vertical alignment mode.
